(19) United States
(12) Patent Application Publication
(10) Pub. No.: US 2026/0167211 A1
(43) Pub. Date: Jun. 18, 2026

(54) NEUTRAL TOW AUTOMATED CONTROL SYSTEMS AND METHODS

(71) Applicant: Ford Global Technologies, LLC, Dearborn, MI (US)

(72) Inventors: Keith Weston, Canton, MI (US); Brendan Diamond, Naples, FL (US); Stuart C. Salter, White Lake, MI (US)

(73) Assignee: Ford Global Technologies, LLC, Dearborn, MI (US)

(21) Appl. No.: 18/980,649

(22) Filed: Dec. 13, 2024

(51) Int. Cl. B60W 50/14; B60H 1/00; B60R 25/20; B60W 10/119; B60W 10/30

(52) U.S. Cl. CPC B60W 50/14; B60W 10/119; B60W 10/30; B60H 1/00849; B60R 25/20; B60W 2554/802; B60W 2556/65

(57) ABSTRACT

A vehicle having a transceiver and a processor is disclosed. The transceiver may receive inputs associated with towing of the vehicle by a towing vehicle. The processor may obtain the inputs from the transceiver and determine that the vehicle is to be towed based on the inputs. Responsive to determining that the vehicle is to be towed, the processor may automatically adjust vehicle operational characteristics.

### FIELD

The present disclosure relates to a vehicle and more particularly to a neutral tow automated control system for a vehicle.

### BACKGROUND

Towing is an act of pulling a vehicle by using a towing vehicle (e.g., a truck, a recreational vehicle (RV), a wheel-lift tow truck, etc.). In some cases, a vehicle may be towed by an RV when the vehicle user desires convenience of having a smaller vehicle for local travel once the user sets up a camp. Further, in some cases, the vehicle may be towed when the vehicle may be inoperable.

The towing vehicle may tow the vehicle in any manner. For example, the towing vehicle may tow the vehicle with all four wheels on ground (also known as “flat towing”). This method enables the vehicle to roll freely behind the towing vehicle. In a further example, the towing vehicle may tow the vehicle by using a tow dolly that lifts two wheels off the ground while the other wheels remain on the ground.

Typically, to enable the vehicle to be towed by the towing vehicle (e.g., RV), the vehicle user should consult the vehicle owner's manual for specific instructions or procedure for towing. The vehicle user may view the specific instructions or procedure and may follow the specific instructions/procedure to enable the towing of the vehicle.

### BRIEF DESCRIPTION OF THE DRAWINGS

The detailed description is set forth with reference to the accompanying drawings. The use of the same reference numerals may indicate similar or identical items. Various embodiments may utilize elements and/or components other than those illustrated in the drawings, and some elements and/or components may not be present in various embodiments. Elements and/or components in the figures are not necessarily drawn to scale. Throughout this disclosure, depending on the context, singular and plural terminology may be used interchangeably.

FIG. 1 depicts an example environment in which techniques and structures for providing the systems and methods disclosed herein may be implemented.

FIG. 2 depicts a block diagram of an example system for controlling vehicle operational characteristics in accordance with the present disclosure.

FIG. 3 depict a snapshot of a notification on a human-machine interface (HMI) in accordance with the present disclosure.

FIG. 4 depicts a flow diagram of an example method for controlling vehicle operational characteristics in accordance with the present disclosure.

### DETAILED DESCRIPTION

### Overview

The present disclosure describes a system and method that facilitates towing of a vehicle by a towing vehicle (e.g., a recreational vehicle, a wheel-lift tow truck, a pick-up truck, etc.). In some aspects, the system may automatically determine that the vehicle is to be towed (or about to be towed) by the towing vehicle. Responsive to determining that the vehicle is to be towed, the system may automatically control/adjust one or more vehicle operational characteristics or automatically implement specific instructions/procedures to place the vehicle in a vehicle tow mode. Stated another way, the system may change the current vehicle operational characteristics to “optimal” vehicle operational characteristics required for efficient vehicle towing, when the system determines that the vehicle is about to be towed by the towing vehicle.

In some aspects, the system may obtain inputs from a vehicle sensor (e.g., a vehicle camera, a radio detection and ranging (radar) sensor, a light detecting and ranging (lidar) sensor, and/or the like) and may automatically determine that the vehicle is to be towed based on the inputs obtained from the vehicle sensor. In some aspects, the inputs may indicate a presence of the towing vehicle in proximity to the vehicle. In further aspects, the inputs may indicate a presence of a connection (e.g., mechanical and/or electrical connection) between the towing vehicle and the vehicle.

In further aspects, the system may may determine that the vehicle is about to be towed based on inputs obtained from the towing vehicle (e.g., via V2V communication), inputs obtained from a vehicle user associated with the vehicle, or any other input related to the vehicle being towed, activated/prepared by the vehicle user.

As described above, responsive to determining that the vehicle is to be towed, the system may automatically control/adjust the vehicle operational characteristics. In some aspects, the system may automatically adjust settings/configuration of a vehicle climate control system that controls a vehicle interior temperature, responsive to determining that the vehicle is to be towed. In an exemplary aspect, the system may operate the vehicle climate control system in a recirculated air mode responsive to determining that the vehicle is to be towed. In the recirculated air mode, the vehicle climate control system may prevent air intake from outside and recirculate and cool the air inside the vehicle. Operating the vehicle climate control system in the recirculated air mode during the towing operation may prevent the vehicle from in-taking exhaust fumes from the towing vehicle.

In further aspects, the system may automatically position a vehicle transfer case in a neutral position responsive to determining that the vehicle is to be towed. The vehicle transfer case may split power from a vehicle transmission and distribute the power between a front axle and a rear axle (or front wheels and rear wheels). Positioning the vehicle transfer case in the neutral position “N” prevents vehicle components from getting impaired during the vehicle towing operation. In further aspects, responsive to determining that the vehicle is to be towed, the system may automatically adjust other vehicle operation characteristics/features including, but not limited to, a vehicle lighting system, a vehicle security system, an advanced driver-assistance system (ADAS), etc., during the vehicle towing operation to enhance vehicle performance/operation during vehicle towing.

The system may activate the vehicle tow mode when the system adjusts the vehicle operational characteristics as described above. In further aspects, the system may output a notification on an infotainment system or human machine interface (HMI) and/or a user device, responsive to activating the vehicle tow mode. The notification may indicate that the vehicle tow mode (or neutral tow mode) is enabled and indicate that the adjustments to the vehicle operation characteristics have been made by the system.

The present disclosure discloses a system and method that automatically activates the vehicle tow mode that may prevent impairment of vehicle components during the towing process. The system provides convenience to the vehicle user as the vehicle user may not have to perform different/multiple steps manually to activate the vehicle tow mode.

These and other advantages of the present disclosure are provided in detail herein.

### Illustrative Embodiments

The disclosure will be described more fully hereinafter with reference to the accompanying drawings, in which example embodiments of the disclosure are shown, and not intended to be limiting.

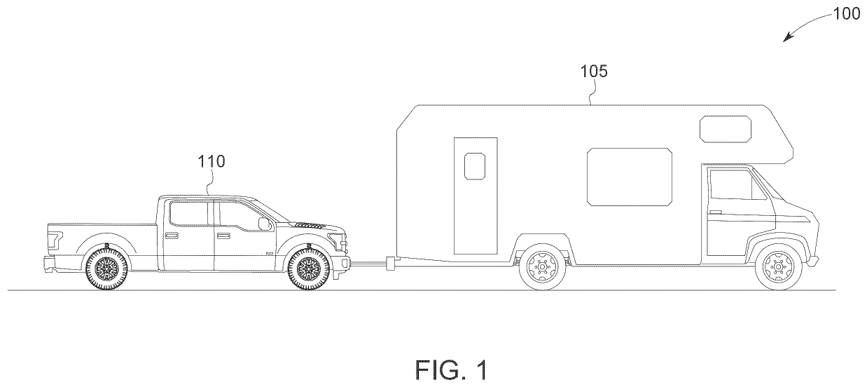

FIG. 1 depicts an example environment 100 in which techniques and structures for providing the systems and methods disclosed herein may be implemented. The environment 100 may include a towing vehicle 105 and a vehicle 110 to be towed by the towing vehicle 105. The towing vehicle 105 may be, for example, a recreational vehicle (such as motorhome, caravan, etc.), a wheel-lift tow truck, a pick-up truck, etc., which may have power and capacity to tow/pull the vehicle 110.

The vehicle 110 may take the form of any passenger or commercial vehicle such as, a car, an off-road vehicle, a work vehicle, a crossover vehicle, a van, a minivan, a taxi, a bus, a truck, etc. Further, the vehicle 110 may be a manually driven vehicle and/or may operate in partially or fully autonomous mode and may include any powertrain such as, a gasoline engine, one or more electrically-actuated motor(s), a hybrid system, etc.

In some aspects, the vehicle 110 and the towing vehicle 105 may be communicatively coupled with each other via vehicle-to-vehicle (V2V) communication. Further, the towing vehicle 105 and the vehicle 110 may be mechanically (and/or magnetically) connected with each other to enable the vehicle towing (e.g., via a hitch system, chains, etc.). In addition, the towing vehicle 105 and the vehicle 110 may be electrically connected (e.g., via a wiring harness that connects the towing vehicle's electrical system to the towed vehicle's electrical system), allowing for proper signaling and operation.

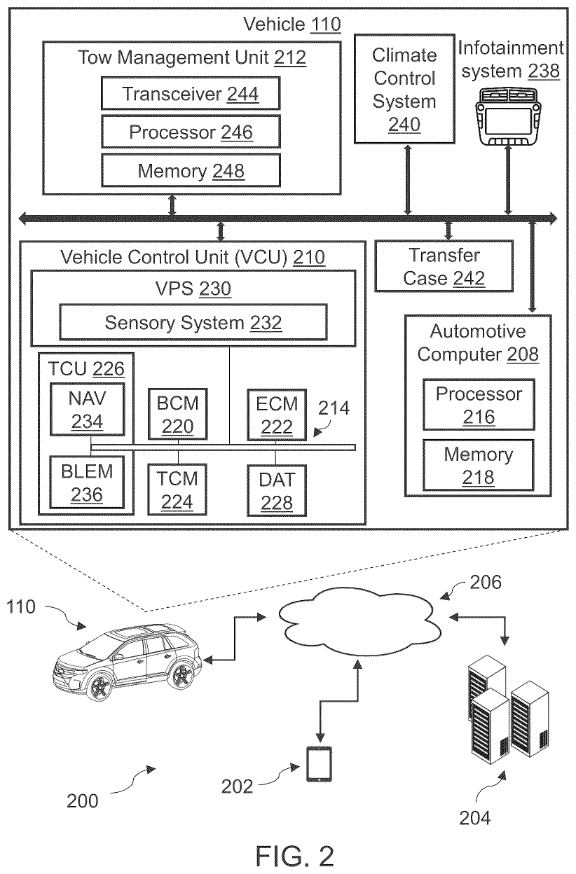

In some aspects, the vehicle 110 may include a tow management unit (shown as tow management unit 212 in FIG. 2) that may manage/control towing of the vehicle 110 by the towing vehicle 105. In some aspects, the tow management unit (“unit”) may automatically determine that the vehicle 110 is to be towed by the towing vehicle 105. Responsive to such determination, the unit may automatically adjust one or more vehicle operational characteristics and enable the vehicle 110 to be towed by the towing vehicle 105 efficiently. In some aspects, the unit may enable the vehicle towing only when the unit changes the vehicle operational characteristics to optimal vehicle operational characteristics required for efficient towing. In an exemplary aspect, the information associated with optimal vehicle operational characteristics may be pre-stored in a vehicle memory (shown as memory 248 in FIG. 2).

In some aspects, the unit may obtain inputs from a vehicle sensor (shown as sensory system 232 in FIG. 2) and determine that the vehicle 110 is to be towed based on the inputs obtained from the vehicle sensor. The vehicle sensor may be, for example, a vehicle camera, a radio detection and ranging (radar) sensor, a light detecting and ranging (lidar) sensor, and/or the like. In some aspects, the vehicle sensor may detect a presence of the towing vehicle 105 in proximity to the vehicle 110. The unit may obtain the inputs associated with the towing vehicle presence from the vehicle sensor and determine that the vehicle 110 is to be towed based on the obtained inputs.

In further aspects, the vehicle sensor may detect a presence of the connection (e.g., electrical and/or mechanical connection) between the towing vehicle 105 and the vehicle 110. The unit may obtain the inputs associated with the connection between the towing vehicle 105 and the vehicle 110 from the vehicle sensor and determine that the towing vehicle 105 and the vehicle 110 may be connected with each other based on the inputs. Responsive to such determination, the unit may automatically determine that the vehicle 110 is to be towed. In addition, the unit may determine that the vehicle 110 is to be towed based on inputs obtained from the towing vehicle 105 (e.g., via V2V communication), inputs obtained from a vehicle user associated with the vehicle 110 via a vehicle Human-Machine Interface (HMI) or a user device, or any other input related to the vehicle 110 being towed, activated/prepared by the vehicle user.

Responsive to determining that the vehicle 110 is to be towed, the unit may automatically adjust settings/configurations of a vehicle climate control system (shown as climate control system 240 in FIG. 2). The vehicle climate control system may control a vehicle interior temperature. In some aspects, the unit may operate the vehicle climate control system in a recirculated air mode responsive to determining that the vehicle 110 is to be towed. In the recirculated air mode, the vehicle climate control system may prevent air intake from outside and recirculate and cool the air inside the vehicle 110. Operating the vehicle climate control system in the recirculated air mode during towing prevents the vehicle 110 from in-taking exhaust fumes from the towing vehicle 105.

In further aspects, responsive to determining that the vehicle 110 is to be towed, the unit may automatically position a vehicle transfer case (shown as transfer case 242 in FIG. 2) in a neutral position. The vehicle transfer case may split power from a vehicle transmission and distribute the power between a vehicle's front axle and a rear axle (or front wheels and rear wheels). It may be appreciated that the transfer case is one of the primary parts of multi-powered axles, such as all-wheel drive and four-wheel drive, and is used to direct power to two or four wheels. Positioning of the vehicle transfer case in the neutral position “N” prevents vehicle components impairment during the vehicle towing. It is known that when the transfer case is in the neutral position, the transfer case disconnects a vehicle engine and the vehicle transmission from the rest of the driveline, which may prevent the vehicle components impairment during the vehicle towing.

In further aspects, responsive to determining that the vehicle 110 is to be towed, the unit may automatically adjust other vehicle operation characteristics/features including, but not limited to, a vehicle lighting system, a vehicle security system, an advanced driver-assistance system (ADAS), etc., during the vehicle towing to enhance vehicle performance/operation during the towing operation.

Further vehicle 110 details are described below in conjunction with FIG. 2.

The vehicle 110 implements and/or performs operations, as described here in the present disclosure, in accordance with the owner manual and safety guidelines. In addition, any action taken by the vehicle user based on the notifications/recommendations provided by the vehicle 110 should comply with all the rules specific to the location and operation of the vehicle 110 (e.g., Federal, state, country, city, etc.). The notifications/recommendations, as provided by the vehicle 110, should be treated as suggestions and only followed according to any rules specific to the location and operation of the vehicle 110.

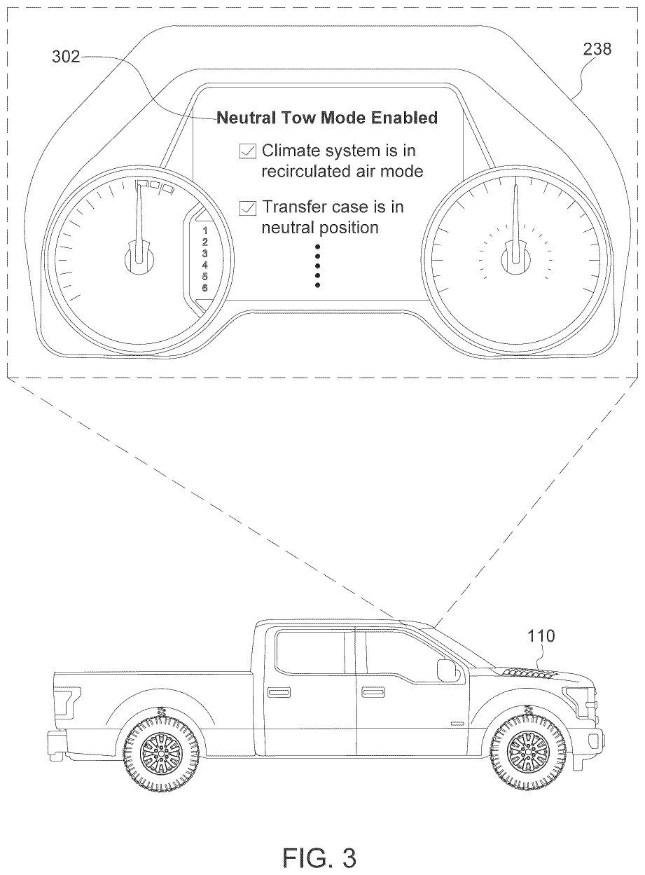

FIG. 2 depicts a block diagram of an example system 200 for controlling vehicle operational characteristics in accordance with the present disclosure. While describing FIG. 2, references will be made to FIG. 3.

The system 200 may include the vehicle 110, a user device 202 and one or more servers 204 (or a server 204) communicatively coupled with each other via one or more networks 206. In some aspects, the user device 202 may be associated with a vehicle user of the vehicle 110 and may be, for example, a mobile phone, a laptop, a tablet, a smartwatch, or any other device having communication capability. The network(s) 206, as described herein, illustrates an example communication infrastructure in which the connected devices discussed in various embodiments of this disclosure may communicate.

The network(s) 206 may be and/or include the Internet, a private network, public network or other configuration that operates using any one or more known communication protocols such as transmission control protocol/Internet protocol (TCP/IP), Bluetooth®, Bluetooth Low Energy (BLE), Wi-Fi based on the Institute of Electrical and Electronics Engineers (IEEE) standard 802.11, Ultra-wideband (UWB), and cellular technologies such as Time Division Multiple Access (TDMA), Code Division Multiple Access (CDMA), High-Speed Packet Access (HSPDA), Long-Term Evolution (LTE), Global System for Mobile Communications (GSM), and Fifth Generation (5G), to name a few examples.

The server 204 may be part of a cloud-based computing infrastructure and may be associated with and/or include a Telematics Service Delivery Network (SDN) that provides digital data services to the vehicle 110 and other vehicles (e.g., the towing vehicle 105, not shown in FIG. 2) that may be part of a vehicle fleet. In further aspects, the server 204 may store information associated with optimal vehicle operation characteristics for placing the vehicle 110 in a vehicle tow mode. The server 204 may transmit the information to the vehicle 110 at a predefined frequency, or when the vehicle 110 transmits a request to the server 204 to obtain such information.

The vehicle 110 may include a plurality of units including, but not limited to, an automotive computer 208, a Vehicle Control Unit (VCU) 210, and a tow management unit 212 (or unit 212). The VCU 210 may include a plurality of Electronic Control Units (ECUs) 214 in communication with the automotive computer 208.

In some aspects, the automotive computer 208 and/or the unit 212 may be installed anywhere in the vehicle 110, in accordance with the disclosure. Further, the automotive computer 208 may operate as a functional part of the unit 212. The automotive computer 208 may be or include an electronic vehicle controller, having one or more processor(s) 216 and a memory 218. Moreover, the unit 212 may be separate from the automotive computer 208 (as shown in FIG. 2) or may be integrated as part of the automotive computer 208.

The processor(s) 216 may be in communication with one or more memory devices in communication with the respective computing systems (e.g., the memory 218 and/or one or more external databases not shown in FIG. 2). The processor(s) 216 may utilize the memory 218 to store programs in code and/or to store data for performing aspects in accordance with the disclosure. The memory 218 may be a non-transitory computer-readable medium or memory storing a tow management program code. The memory 218 may include any one or a combination of volatile memory elements (e.g., dynamic random-access memory (DRAM), synchronous dynamic random-access memory (SDRAM), etc.) and may include any one or more nonvolatile memory elements (e.g., erasable programmable read-only memory (EPROM), flash memory, electronically erasable programmable read-only memory (EEPROM), programmable read-only memory (PROM), etc.).

In accordance with some aspects, the VCU 210 may share a power bus with the automotive computer 208 and may be configured and/or programmed to coordinate the data between vehicle 110 systems, connected servers (e.g., the server(s) 204), and other vehicles (not shown in FIG. 2) operating as part of a vehicle fleet. The VCU 210 may include or communicate with any combination of the ECUs 214, such as a Body Control Module (BCM) 220, an Engine Control Module (ECM) 222, a Transmission Control Module (TCM) 224, a Telematics Control Unit (TCU) 226, a Driver Assistances Technologies (DAT) controller 228, etc. The VCU 210 may further include and/or communicate with a Vehicle Perception System (VPS) 230, having connectivity with and/or control of one or more vehicle sensory system(s) 232 (or sensory system 232 or “sensor unit”).

The vehicle sensory system 232 may include one or more vehicle sensors including, but not limited to, a radio detection and ranging (radar) sensor configured for detection and localization of objects inside and outside the vehicle 110 using radio waves, sitting area buckle sensors, sitting area sensors, a light detecting and ranging (lidar) sensor, door sensors, proximity sensors, temperature sensors, wheel sensors, ambient weather sensors, vehicle internal and external cameras, one or more rain sensors, capacitive moisture sensors, a tire pressure sensor, ultrasonic sensors, etc. In some aspects, the vehicle sensory system(s) 232 and the TCU 226 may collectively be considered as a vehicle “sensor unit” that transmits inputs (e.g., images, real-time vehicle geolocation, etc.) to the unit 212.

The vehicle sensory system(s) 232 may capture inputs (e.g., images) associated with the vehicle's surroundings via, for example, the vehicle cameras, the radar sensors, the lidar sensors, and/or the like. In some aspects, the vehicle sensory system(s) 232 may detect a presence of the towing vehicle 105 in proximity to the vehicle 110 and may detect a presence of a connection (e.g., mechanical and/or electrical connection) between the towing vehicle 105 and the vehicle 110. In some aspects, the vehicle sensory system(s) 232 may detect the electrical connection between the towing vehicle 105 and the vehicle 110 by detecting an exchange/flow of current between the towing vehicle 105 and the vehicle 110.

In some aspects, the VCU 210 may control vehicle operational aspects and implement one or more instruction sets received from the user device 202, from one or more instruction sets stored in the memory 218, including instructions operational as part of the unit 212.

The TCU 226 may be configured and/or programmed to provide vehicle connectivity to wireless computing systems onboard and off board the vehicle 110 and may include a Navigation (NAV) receiver 234 for receiving and processing a GPS signal, a BLE Module (BLEM) 236, a Wi-Fi transceiver, a UWB transceiver, and/or other wireless transceivers (not shown in FIG. 2) that may be configurable for wireless communication (including cellular communication) between the vehicle 110 and other systems (e.g., the user device 202, a key fob, an NFC device, etc.), computers, and modules. The NAV receiver 234 may be configured to determine the real-time vehicle geolocation. The TCU 226 may be in communication with the ECUs 214 by way of a bus.

The ECUs 214 may control aspects of vehicle operation and communication using inputs from human drivers, inputs from an autonomous vehicle controller, the unit 212, and/or via wireless signal inputs received via the wireless connection(s) from other connected devices, such as the user device 202, the server(s) 204, among others.

The BCM 220 generally includes integration of sensors, vehicle performance indicators, and variable reactors associated with vehicle systems and may include processor-based power distribution circuitry that can control functions associated with the vehicle body such as vehicle lights, windows, security, camera(s), fan, headlights, audio system(s), speakers, wipers, door locks and access control, mirrors, a climate control system 240, a transfer case 242 (described in FIG. 1), various comfort controls, enclosures, and/or the like. The BCM 220 may also operate as a gateway for bus and network interfaces to interact with remote ECUs (not shown in FIG. 2).

The DAT controller 228 may provide Level-1 through Level-3 automated driving and driver assistance functionality that may include, for example, active parking assistance, vehicle backup assistance, an advanced driver-assistance system (ADAS), and adaptive cruise control, among other features. The DAT controller 228 may also provide aspects of user and environmental inputs usable for user authentication.

In some aspects, the automotive computer 208 may connect with an infotainment system 238 (or a vehicle Human-Machine Interface (HMI) 238). The infotainment system 238 may include a touchscreen interface portion and may include voice recognition features, biometric identification capabilities that can identify users based on facial recognition, voice recognition, fingerprint identification, or other biological identification means. In other aspects, the infotainment system 238 may be further configured to receive user instructions/inputs via the touchscreen interface portion and/or display notifications/recommendations, navigation maps, etc. on the touchscreen interface portion.

The computing system architecture of the automotive computer 208, the VCU 210, and/or the unit 212 may omit certain computing modules. It should be readily understood that the computing environment depicted in FIG. 2 is an example of a possible implementation according to the present disclosure, and thus, it should not be considered limiting or exclusive.

In accordance with some aspects, the unit 212 may be integrated with and/or executed as part of the ECUs 214. The unit 212, regardless of whether it is integrated with the automotive computer 208 or the ECUs 214, or whether it operates as an independent computing system in the vehicle 110, may include a transceiver 244, a processor 246, and a computer-readable memory 248.

The transceiver 244 may receive information/inputs from one or more external devices or systems (e.g., the user device 202, the server(s) 204, and/or the like) via the network 206. For example, the transceiver 244 may receive inputs from the user device 202 to activate a vehicle tow mode. In addition, the transceiver 244 may receive the information associated with the optimal vehicle operation characteristics from the server 204 via the network 206. Further, the transceiver 244 may transmit notifications (e.g., alert/alarm signals) to the external devices or systems. In addition, the transceiver 244 may receive information/inputs from vehicle 110 components such as the infotainment system 238, the vehicle sensory system 232, the TCU 226, and/or the like. Further, the transceiver 244 may transmit notifications (e.g., alert/alarm/command signals) to the vehicle 110 components such as the infotainment system 238, the BCM 220, etc.

The processor 246 and the memory 248 may be the same as or similar to the processor 216 and the memory 218, respectively. In some aspects, the processor 246 may utilize the memory 248 to store programs in code and/or to store data for performing aspects in accordance with the disclosure. The memory 248 may be a non-transitory computer-readable medium or memory storing the tow management program code. In some aspects, the memory 248 may store the information associated with optimal vehicle operation characteristics that the vehicle 110 obtains from the server 204.

In operation, the transceiver 244 may receive inputs associated with towing of the vehicle 110 by the towing vehicle 105. In some aspects, the transceiver 244 may receive the inputs from a vehicle sensor (or the vehicle sensory system 232). As described above, the vehicle sensor may detect the presence of the towing vehicle 105 in proximity to the vehicle 110. In addition, the vehicle sensor may detect a connection (e.g., mechanical and/or electrical connection) between the vehicle 110 and the towing vehicle 105.

In further aspects, the transceiver 244 may receive the inputs from the towing vehicle 105, via V2V communication, which indicates that the towing vehicle 105 is about to tow the vehicle 110. In addition, the transceiver 244 may obtain the inputs from the infotainment system 238. For example, the transceiver 244 may receive a user request or user input to activate the vehicle tow mode via the infotainment system 238 (or the user device 202), which may indicate that the vehicle 110 is about to be towed. In additional aspects, the transceiver 244 may receive any other input related to the vehicle 110 being towed and/or activated/prepared by the vehicle user for towing.

Responsive to receiving the inputs described above, the transceiver 244 may transmit the inputs to the processor 246. The processor 246 may obtain the inputs from the transceiver 244 and may determine that the vehicle 110 is about to be towed by the towing vehicle 105 based on the obtained inputs. For example, the processor 246 may determine that the vehicle 110 is about to be towed when the vehicle sensory system 232 detects that the vehicle 110 is connected to the towing vehicle 105 (via mechanical and/or electrical connection). In further aspects, the processor 246 may determine that the vehicle 110 is about to be towed when the processor 246 obtain inputs from the towing vehicle 105 via V2V communication, which indicates that the towing vehicle 105 may tow the vehicle 110. In further aspects, the processor 246 may determine that the vehicle 110 is about to be towed when the processor 246 obtains the user inputs from the infotainment system 238 and/or the user device 202 (via the transceiver 244), which includes the user request to activate the vehicle tow mode.

In additional aspects, the processor 246 may determine that the vehicle 110 is about to be towed when the vehicle sensory system 232 detects the presence of the towing vehicle 105 in proximity to the vehicle 110. In this case, the processor 246 may obtain the inputs from the vehicle sensory system 232 and identify a distance between the vehicle 110 and the towing vehicle 105 based on the obtained inputs. Responsive to identifying the distance, the processor 246 may compare the distance with a predetermined threshold value. The processor 246 may determine that the vehicle 110 is about to be towed when the distance is less than the predetermined threshold value. Stated another way, the processor 246 may determine that the vehicle 110 is about to be towed when the towing vehicle 105 may be located adjacent (or close) to the vehicle 110.

Responsive to determining that the vehicle 110 is about to be towed, the processor 246 may automatically adjust one or more vehicle operational characteristics to optimal vehicle operational characteristics, to enable an efficient vehicle towing operation. In some aspects, the processor 246 may obtain/fetch the information associated with the optimal vehicle operational characteristics from the memory 248 responsive to determining that the vehicle 110 is about to be towed and adjust the current vehicle operational characteristics to the optimal vehicle operational characteristics based on the obtained information. Examples of the vehicle operational characteristics that are adjusted are described below. The described examples should not be construed as limiting.

In some aspects, the processor 246 may operate the climate control system 240 in a recirculated air mode, responsive to determining that the vehicle 110 is about to be towed. The climate control system 240 may control the vehicle interior temperature. In the recirculated air mode, the climate control system 240 may prevent air intake from outside and recirculate and cool the air inside the vehicle 110. Operating the climate control system 240 in the recirculated air mode during the towing operation prevents the vehicle 110 from in-taking exhaust fumes from the towing vehicle 105.

In further aspects, the processor 246 may automatically position the transfer case 242 in a neutral position, responsive to determining that the vehicle 110 is about to be towed. Keeping the transfer case 242 in the neutral position during the vehicle towing operation is crucial, particularly when the towing vehicle 105 may be flat-towing the vehicle 110 (with all four wheels on the ground). Positioning the transfer case 242 in the neutral position prevents the vehicle components from getting impaired during the vehicle towing operation. For instance, in the neutral position, the transfer case 242 disconnects a vehicle engine and the vehicle transmission from the rest of the driveline. This prevents the drivetrain components (such as the transmission, transfer case, and driveshafts) from turning while the vehicle 110 is being towed.

In addition, responsive to determining that the vehicle 110 is about to be towed, the processor 246 may automatically adjust other vehicle operation characteristics/features including, but not limited to, a vehicle lighting system, a vehicle security system, ADAS, etc., during the vehicle towing operation to enhance vehicle performance/operation during vehicle towing. For instance, the processor 246 may disable the vehicle lighting system, the vehicle security system, ADAS, etc., during the vehicle towing operation.

The processor 246 may enable the vehicle 110 to be towed by the towing vehicle 105 responsive to automatically adjusting the vehicle operational characteristics as described above. Stated another way, the processor 246 may activate the vehicle tow mode responsive to automatically adjusting the vehicle operational characteristics described above. In some aspects, the processor 246 may enable the vehicle tow mode after authenticating the vehicle user (e.g., via facial recognition or other form of dual factor authentication).

In some aspects, the processor 246 may output a notification 302 (shown in FIG. 3) on the infotainment system 238 (and/or the user device 202) responsive to activating the vehicle tow mode. The notification 302 may indicate that the vehicle tow mode (or neutral tow mode) is enabled. In some aspects, the notification 302 may further indicate the adjustments to the vehicle operation characteristics made by the processor 246 before enabling the vehicle tow mode. Stated another way, the notification 302 may indicate the optimal vehicle operational characteristics that the processor 246 has adjusted for the vehicle 110 to enable efficient towing operation. For instance, the notification 302 may indicate that the climate control system 240 is in the recirculated air mode, the transfer case 242 is in the neutral position, and/or the like.

The processor 246 may perform one or more additional operations to further enhance the efficacy of the towing operation. For instance, the processor 246 may determine a real-time status of the adjustment of the vehicle operational characteristics and may output a notification for the vehicle user indicating the real-time status. Stated another way, the processor 246 may output real-time notifications (via the infotainment system 238 and/or the user device 202) to indicate the status of the adjustment of the vehicle operational characteristics. For instance, the processor 246 may output a first notification when the processor 246 turns-on the recirculated air mode. Further, the processor 246 may output a second notification when the processor 246 places the transfer case 242 in the neutral position. In some aspects, the notification may include a visual signal or an audio notification. For instance, the processor 246 may flash vehicle lights continuously while the processor 246 may be working on the adjustment of the vehicle operational characteristics.

In further aspects, the processor 246 may determine that the towing vehicle 105 may be towing the vehicle 110 based on the inputs obtained from the VCU 210 (e.g., based on inputs obtained from the vehicle camera, lidar sensor, radar sensor, etc.). Responsive to determining that the towing vehicle 105 may be towing the vehicle 110, the processor 246 may enable or cause climate conditioning in a vehicle interior portion (e.g., maintain temperature, humidity, air quality inside the vehicle 110), or other vehicle features. In some aspects, the vehicle 110 may power such features by using energy regeneration (e.g., generation of energy due to speed reduction) or the existing energy onboard the vehicle 110 while the vehicle 110 is being towed.

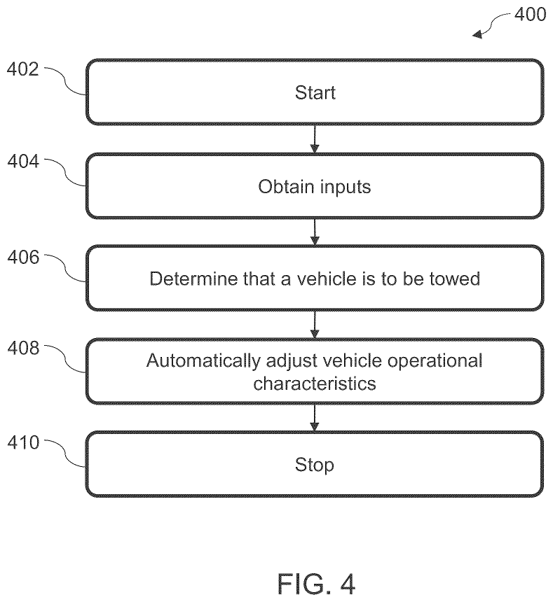

FIG. 4 depicts a flow diagram of an example method 400 for controlling vehicle operational characteristics in accordance with the present disclosure. FIG. 4 may be described with continued reference to prior figures. The following process is exemplary and not confined to the steps described hereafter. Moreover, alternative embodiments may include more or less steps than are shown or described herein and may include these steps in a different order than the order described in the following example embodiments.

Referring to FIG. 4, at step 402, the method 400 may commence. At step 404, the method 400 may include obtaining, by the processor 246, the inputs associated with towing of the vehicle 110 by the towing vehicle 105. At step 406, the method 400 may include determining, by the processor 246, that the vehicle 110 is to be towed based on the inputs. At step 408, the method 400 may include automatically adjusting, by the processor 246, the vehicle operational characteristics responsive to determining that the vehicle 110 is to be towed, as described above.

At step 410, the method 400 may stop.

In the above disclosure, reference has been made to the accompanying drawings, which form a part hereof, which illustrate specific implementations in which the present disclosure may be practiced. It is understood that other implementations may be utilized, and structural changes may be made without departing from the scope of the present disclosure. References in the specification to “one embodiment,” “an embodiment,” “an example embodiment,” etc., indicate that the embodiment described may include a particular feature, structure, or characteristic, but every embodiment may not necessarily include the particular feature, structure, or characteristic. Moreover, such phrases are not necessarily referring to the same embodiment. Further, when a feature, structure, or characteristic is described in connection with an embodiment, one skilled in the art will recognize such feature, structure, or characteristic in connection with other embodiments whether or not explicitly described.

Further, where appropriate, the functions described herein can be performed in one or more of hardware, software, firmware, digital components, or analog components. For example, one or more application specific integrated circuits (ASICs) can be programmed to carry out one or more of the systems and procedures described herein. Certain terms are used throughout the description and claims refer to particular system components. As one skilled in the art will appreciate, components may be referred to by different names. This document does not intend to distinguish between components that differ in name, but not function.

It should also be understood that the word “example” as used herein is intended to be non-exclusionary and non-limiting in nature. More particularly, the word “example” as used herein indicates one among several examples, and it should be understood that no undue emphasis or preference is being directed to the particular example being described.

A computer-readable medium (also referred to as a processor-readable medium) includes any non-transitory (e.g., tangible) medium that participates in providing data (e.g., instructions) that may be read by a computer (e.g., by a processor of a computer). Such a medium may take many forms, including, but not limited to, non-volatile media and volatile media. Computing devices may include computer-executable instructions, where the instructions may be executable by one or more computing devices such as those listed above and stored on a computer-readable medium.

With regard to the processes, systems, methods, heuristics, etc. described herein, it should be understood that, although the steps of such processes, etc. have been described as occurring according to a certain ordered sequence, such processes could be practiced with the described steps performed in an order other than the order described herein. It further should be understood that certain steps could be performed simultaneously, that other steps could be added, or that certain steps described herein could be omitted. In other words, the descriptions of processes herein are provided for the purpose of illustrating various embodiments and should in no way be construed so as to limit the claims.

Accordingly, it is to be understood that the above description is intended to be illustrative and not restrictive. Many embodiments and applications other than the examples provided would be apparent upon reading the above description. The scope should be determined, not with reference to the above description, but should instead be determined with reference to the appended claims, along with the full scope of equivalents to which such claims are entitled. It is anticipated and intended that future developments will occur in the technologies discussed herein, and that the disclosed systems and methods will be incorporated into such future embodiments. In sum, it should be understood that the application is capable of modification and variation.

All terms used in the claims are intended to be given their ordinary meanings as understood by those knowledgeable in the technologies described herein unless an explicit indication to the contrary is made herein. In particular, use of the singular articles such as “a,” “the,” “said,” etc. should be read to recite one or more of the indicated elements unless a claim recites an explicit limitation to the contrary. Conditional language, such as, among others, “can,” “could,” “might,” or “may,” unless specifically stated otherwise, or otherwise understood within the context as used, is generally intended to convey that certain embodiments could include, while other embodiments may not include, certain features, elements, and/or steps. Thus, such conditional language is not generally intended to imply that features, elements, and/or steps are in any way required for one or more embodiments.

1. A vehicle comprising:
a transceiver configured to receive inputs associated with towing of the vehicle by a towing vehicle;
a memory storing a set of optimal vehicle operational characteristics corresponding to operation of a plurality of components of the vehicle during towing of the vehicle; and
a processor configured to:
obtain the inputs from the transceiver;
determine that the vehicle is to be towed based on the inputs;
obtain the optimal vehicle operational characteristics from the memory; and
automatically adjust vehicle operational characteristics to the optimal vehicle operational characteristics responsive to determining that the vehicle is to be towed, wherein automatically adjusting the vehicle operational characteristics to the optimal vehicle operational characteristics comprises causing a vehicle transfer case of the vehicle to be positioned in a neutral mode, and wherein the vehicle transfer case is configured to split power from a vehicle transmission of the vehicle and distribute the power between a front axle and a rear axle of the vehicle.

2. The vehicle of claim 1, wherein the processor is further configured to:
enable the vehicle to be towed by the towing vehicle responsive to automatically adjusting the vehicle operational characteristics.

3. The vehicle of claim 1, wherein the processor is further configured to:
determine a status of the adjustment of the vehicle operational characteristics; and
output a notification indicating the status of the adjustment of the vehicle operational characteristics.

4. The vehicle of claim 3, wherein the notification comprises a visual signal or an

5. The vehicle of claim 1, wherein the transceiver receives the inputs from a human-machine interface (HMI), and wherein the HMI is configured to receive a user request to activate a vehicle tow mode.

6. The vehicle of claim 1, wherein the transceiver receives the inputs from a vehicle sensor.

7. The vehicle of claim 6, wherein the vehicle sensor is configured to detect a presence of the towing vehicle in proximity to the vehicle.

8. The vehicle of claim 6, wherein the vehicle sensor is configured to detect a connection between the vehicle and the towing vehicle.

9. The vehicle of claim 7, wherein the processor is further configured to:
obtain the inputs from the vehicle sensor;
identify a distance between the vehicle and the towing vehicle based on the inputs;
compare the distance with a predetermined threshold value; and
determine that the vehicle is to be towed when the distance is less than the predetermined threshold value.

10. The vehicle of claim 1, wherein the transceiver receives the inputs from the towing vehicle via vehicle-to-vehicle (V2V) communication.

11. The vehicle of claim 1, wherein automatically adjusting the vehicle operational characteristics to the optimal vehicle operational characteristics further comprises causing a vehicle climate control system of the vehicle to operate in a recirculated air mode.

12. The vehicle of claim 1, wherein the processor is further configured to output a notification while the processor automatically adjusts the vehicle operational characteristics to the optimal vehicle operational characteristics.

13. The vehicle of claim 1, wherein automatically adjusting the vehicle operational characteristics to the optimal vehicle operational characteristics further comprises disabling a vehicle lighting system.

14. The vehicle of claim 1, wherein automatically adjusting the vehicle operational characteristics to the optimal vehicle operational characteristics further comprises disabling a vehicle security system.

15. The vehicle of claim 1, wherein automatically adjusting the vehicle operational characteristics to the optimal vehicle operational characteristics further comprises disabling an advanced driver-assistance system (ADAS).

16. The vehicle of claim 1, wherein the processor is further configured to:
determine that the towing vehicle is towing the vehicle; and
enable climate conditioning in a vehicle interior portion responsive to determining that the towing vehicle is towing the vehicle.

17. A method comprising:
obtaining, by a processor of a vehicle, inputs associated with towing of the vehicle by a towing vehicle;
determining, by the processor, that the vehicle is to be towed based on the inputs;
obtaining, by the processor, from a memory of the vehicle, a set of optimal vehicle operational characteristics corresponding to operation of a plurality of components of the vehicle during towing of the vehicle; and
automatically adjusting, by the processor, vehicle operational characteristics to the optimal vehicle operational characteristics responsive to determining that the vehicle is to be towed, wherein automatically adjusting the vehicle operational characteristics to the optimal vehicle operational characteristics comprises causing a vehicle transfer case of the vehicle to be positioned in a neutral mode, and wherein the vehicle transfer case is configured to split power from a vehicle transmission of the vehicle and distribute the power between a front axle and a rear axle of the vehicle.

18. The method of claim 17, further comprising:
obtaining the inputs from a vehicle sensor;
identifying a distance between the vehicle and the towing vehicle;
comparing the distance with a predetermined threshold value; and
determining that the vehicle is to be towed when the distance is less than the predetermined threshold value.

19. The method of claim 17, further comprising obtaining the inputs from the towing vehicle via vehicle-to-vehicle (V2V) communication.

20. A non-transitory computer-readable storage medium having instructions stored thereupon which, when executed by a processor, cause the processor to:
obtain inputs associated with towing of a vehicle by a towing vehicle;
determine that the vehicle is to be towed based on the inputs;
obtain, from a memory of the vehicle, a set of optimal vehicle operational characteristics corresponding to operation of a plurality of components of the vehicle during towing of the vehicle; and
automatically adjust vehicle operational characteristics to the optimal vehicle operational characteristics responsive to determining that the vehicle is to be towed, wherein automatically adjusting the vehicle operational characteristics to the optimal vehicle operational characteristics comprises causing a vehicle transfer case of the vehicle to be positioned in a neutral mode, and wherein the vehicle transfer case is configured to split power from a vehicle transmission of the vehicle and distribute the power between a front axle and a rear axle of the vehicle.
